(19) United States
(12) Patent Application Publication
(10) Pub. No.: US 2022/0100711 A1
(43) Pub. Date: Mar. 31, 2022

(54) INFORMATION PROCESSING APPARATUS AND STORAGE DESTINATION MANAGEMENT METHOD FOR INFORMATION PROCESSING APPARATUS

(71) Applicant: SHARP KABUSHIKI KAISHA, Osaka (JP)

(72) Inventor: KENICHIROH IMAYOSHI, Osaka (JP)

(21) Appl. No.: 17/483,687

(22) Filed: Sep. 23, 2021

(30) Foreign Application Priority Data
Sep. 28, 2020 (JP) 2020-162287

(51) Int. Cl. G06F 16/185; G06F 16/11; G06F 16/16; H04N 1/32

(52) U.S. Cl. CPC G06F 16/185; H04N 1/32101; G06F 16/16; G06F 16/122

(57) ABSTRACT

An information processing apparatus includes: a user path setter that initially sets, for each user, initial path information up to a storage destination folder for storing input data; a storage folder path generator that generates a storage destination folder path indicating a hierarchical structure up to the storage destination folder and including the initial path information as a part of the hierarchical structure; and a data storage executor that, when data related to a user is input by the user, stores the data input by the user in the storage destination folder by using the generated storage destination folder path. The initial path information includes a custom destination that is user-specific path information initially set by each user.

### CROSS-REFERENCE TO RELATED APPLICATION

The present application claims priority from Japanese Patent Application Number 2020-162287, the content to which is hereby incorporated by reference into this application.

### BACKGROUND OF THE INVENTION

### 1. Field of the Invention

One aspect of the present invention relates to an information processing apparatus, particularly to an information processing apparatus having a function to store information, such as input image data, in a storage location desired by a user.

### 2. Description of the Related Art

Conventionally, when information such as input image data is stored by an information processing apparatus such as a personal computer or an image forming apparatus, the information is stored in a folder designated by a user, or the like, or a previously set default folder.

When information such as image data is transmitted to the other information processing apparatus such as a server, the information is sometimes transmitted to the designated storage destination folder of the destination apparatus.

For example, when a file or a printer is shared between an information processing apparatus and a server, a storage destination folder of the server is designated and image data is transmitted by using a communication protocol such as Server Message Block (SMB).

In this case, when the user intends to send image data and desires to designate a specific folder set by the user as a storage destination folder of the server, the user previously sets and registers the path information up to the location of the folder or directly enters the path information each time the image data is transmitted.

Japanese Unexamined Patent Application Publication No. 2014-212453 discloses an image processing system in which a common path that is commonly used by a plurality of users and is used as a part of path information of a folder that is the storage destination of image data is previously entered and stored in an image forming apparatus by an administrator, and when a user ID, a password, and a login domain are selected by a user to transmit image data from the image forming apparatus to a file server, the path information of the folder as the storage destination is set by adding the entered user ID and the entered domain to the end of the common path, and when the connection with the file server is successfully established, the image data is transmitted to the file server and is stored in the folder indicated by the set path information.

### SUMMARY OF THE INVENTION

Unfortunately, as is the case with conventional information processing apparatuses, it is very time-consuming for a user to directly enter the path information up to the location of the storage destination folder each time in order to transmit the image data.

As the path information up to the location of the user-specified folder may have many hierarchical levels and include a very long character string, there is a high possibility of incorrect entry, and the user's operational burden is extremely high.

If the path information up to the location of the user-specified folder is previously set and registered, the path information may be reused; however, when a large number of users use the same information processing apparatus, the path information to be set for each user may be different, and therefore the path information needs to be set and registered by each user. In conventional information processing apparatuses, in a case where a large number of users of the information processing apparatus include, for example, a plurality of users belonging to the same department, even when a first half part of the character string of the path information up to the location of the user-specified storage destination folder is common though the name of the user-specified storage destination folder itself is different, each user needs to enter the entire path information including the common character string, which causes a heavy operational burden on each user when setting the path information of the storage destination folder.

In Japanese Unexamined Patent Application Publication No. 2014-212453, the common path is previously stored so that the entry of a part of the path information of the storage destination folder may be omitted. However, there is a disadvantage such that each user is not able to change it on his/her own as the administrator sets and enters the common path part and, as the path information of the storage destination of the image data to be transmitted by the user is fixed to the path information including the user ID used for user authentication and the domain, the user is not able to flexibly set and enter the path information up to the location of the folder for storing the image data.

One aspect of the present invention has been made in consideration of the above circumstances, and it is an object of the present invention to provide an information processing apparatus with which it is possible to increase variations (the number of selections) for setting user-specific path information indicating the location of a folder for storing information such as image data for each user when the user intends to store the information in a desired folder and to reduce the user's operational burden when setting and entering the storage location of the information.

One aspect of the present invention is to provide an information processing apparatus including: a user path setter that initially sets, for each user, initial path information up to a storage destination folder for storing input data; a storage folder path generator that generates a storage destination folder path indicating a hierarchical structure up to the storage destination folder and including the initial path information as a part of the hierarchical structure; and a data storage executor that, when data related to a user is input by the user, stores the data input by the user in the storage destination folder by using the generated storage destination folder path, wherein the initial path information includes a custom destination that is user-specific path information initially set by each user.

A user identification information setter is further included, which initially sets user identification information including user identification, wherein the custom destination includes path information indicating a hierarchical structure from an identification folder, with which the initially set user identification is identifiable, up to the storage destination folder.

A system path setter is further included, which initially sets system path information that is common path information to users of the information processing apparatus as path information up to the storage destination folder for storing data, wherein the storage destination folder path is generated as path information combining the system path information and the custom destination.

An operator and a display are further included, wherein the display presents a diagrammatic screen using a hierarchical structure to indicate a relationship of a plurality of folders up to the storage destination folder, and the user uses the operator to select a folder to be set as a storage location for storing data from the plurality of folders presented on the diagrammatic screen and thus initially sets the custom destination.

A storage is further included, in which a plurality of folders is previously set and is associated with each other by a predetermined hierarchical structure, wherein the storage destination folder for storing data input by a user is any of the plurality of folders.

A communicator is further included, which transmits data to another information processing apparatus via a network, wherein the another information processing apparatus includes a storage in which a plurality of folders is previously set and is associated with each other by a predetermined hierarchical structure, the storage destination folder is a folder previously set in the storage of the another information processing apparatus, the communicator designates the storage destination folder as a storage destination for the input data and transmits the input data to the another information processing apparatus, and the data received by the another information processing apparatus is stored in the storage destination folder in the storage of the another information processing apparatus.

One aspect of the present invention is a storage destination management method for an information processing apparatus, the information processing apparatus includes a storage in which a plurality of folders is previously set and is associated with each other by a predetermined hierarchical structure, and the storage destination management method includes: when a user selects a desired folder from the plurality of folders in the storage, initially setting, for each user, initial path information up to a storage destination folder that is a storage location for storing input data so as to set the selected folder as the storage destination folder; generating a storage destination folder path indicating a hierarchical structure up to the storage destination folder and including the initial path information as a part of the hierarchical structure; and when data related to a user is input by the user, storing the data input by the user in the storage destination folder by using the generated storage destination folder path.

According to one aspect of the present invention, the user path setter is included, which initially sets, for each user, the initial path information up to the storage destination folder that is the storage location for storing input data, and the storage folder path generator is included, which generates the storage destination folder path indicating the hierarchical structure up to the storage destination folder and including the initial path information as a part of the hierarchical structure; therefore, when the user intends to store the input data in the desired folder, it is possible to increase variations (the number of selections) for setting the user's path information indicating the location of the folder for storing the data for each user and to reduce the user's operational burden when setting and entering the storage location of the information.

### BRIEF DESCRIPTION OF THE DRAWINGS

FIG. 1 is a configuration block diagram of an image forming apparatus according to an embodiment of the present invention.

FIG. 2 is an explanatory diagram of information stored in a storage according to an embodiment of the present invention.

FIG. 3 is an explanatory diagram of information stored in the storage according to an embodiment of the present invention.

FIG. 4 is an explanatory diagram of information stored in the storage according to an embodiment of the present invention.

FIG. 5 is an explanatory diagram of a hierarchical structure of storage folders according to an embodiment of the present invention.

FIG. 6 is an explanatory diagram of a setting screen for system path information presented on a display according to an embodiment of the present invention.

FIG. 7 is an explanatory diagram of an entry screen for user registration information presented on the display according to an embodiment of the present invention.

FIG. 8 is an explanatory diagram of an entry screen for user authentication information presented on the display according to an embodiment of the present invention.

FIG. 9 is an explanatory diagram of a display screen for a storage destination folder presented on the display according to an embodiment of the present invention.

FIG. 10 is an explanatory diagram of storage destination information according to an embodiment of the present invention.

FIG. 11 is an explanatory diagram of a setting screen for system path information presented on the display according to another embodiment of the present invention.

FIG. 12 an explanatory diagram of a setting screen for user registration information presented on the display according to another embodiment of the present invention.

FIG. 13 is an explanatory diagram of a display screen for a storage destination folder presented on the display according to an embodiment of the present invention.

FIG. 14 is an explanatory diagram of a display screen for changing the storage destination folder according to an embodiment of the present invention.

FIG. 15 is a flowchart of an initial setting process of a storage destination folder according to an embodiment of the present invention.

FIG. 16 is a flowchart of the initial setting process of the storage destination folder according to an embodiment of the present invention.

FIG. 17 is a flowchart of the initial setting process of the storage destination folder according to another embodiment of the present invention.

FIG. 18 is a flowchart of the initial setting process of the storage destination folder according to another embodiment of the present invention.

FIG. 19 is a flowchart of an image reading process according to an embodiment of the present invention.

### DETAILED DESCRIPTION OF THE INVENTION

An embodiment that is one aspect of the present invention is described below with reference to the drawings. The present invention is not limited to the description of the embodiments below.

Although one aspect of the present invention is an information processing apparatus, the information processing apparatus includes various apparatuses such as personal computers, communication devices, display devices, image processing apparatuses, and image forming apparatuses, and the embodiments below are applicable to any of these information processing apparatuses.
In the embodiments described below, an image forming apparatus, included in the information processing apparatuses, receives input of a document containing information such as images, graphics, and characters, and performs functions such as printing.

Information such as image data input to the image forming apparatus, or the like, is classified and stored in a predetermined storage location (hereinafter referred to as “folder”) of a storage device inside the image forming apparatus or is transmitted from the image forming apparatus to the other information processing apparatus such as a server via a network and is classified and stored in a predetermined folder of the other information processing apparatus.

In the case described according to the embodiment below, the image data input to the image forming apparatus is stored in a predetermined folder inside the image forming apparatus.
The folder, which is a storage location, is not necessarily a folder that is set inside the image forming apparatus but may also be a folder that is set inside the other information processing apparatus, such as a server, connected via a network.

Configuration of Image Forming Apparatus

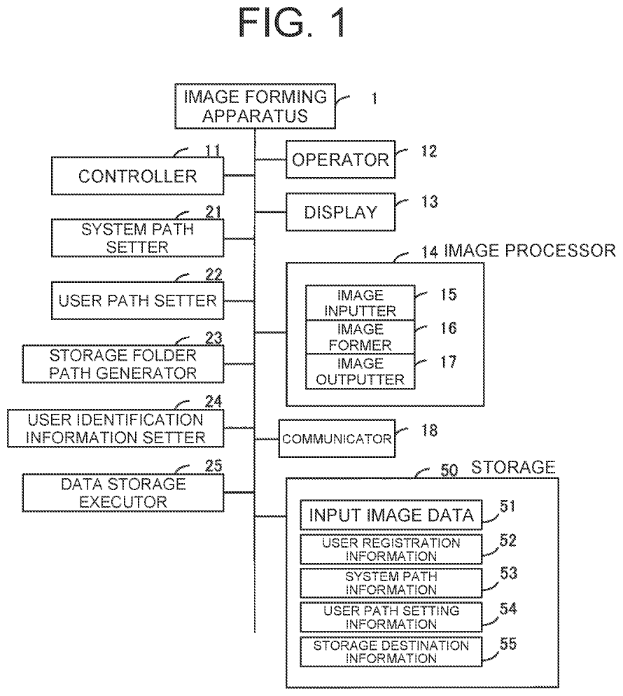

FIG. 1 is a configuration block diagram of an image forming apparatus according to an embodiment of the present invention.
An image forming apparatus (hereinafter also referred to as “multifunction peripheral (MFP)”) 1 is an apparatus that processes image data and is, for example, an electronic apparatus having a duplication (copying) function, a printing function, a document reading (scanning) function, a document editing function, a document storage function, a document transmission (fax) function, and a communication function.
Although the image forming apparatus 1 which is one aspect of the present invention has, in particular, a printing function and a document reading (scanning) function in the description according to the embodiment below, the image forming apparatus 1 may also have other functions.

As illustrated in FIG. 1, the image forming apparatus (MFP) 1, which is one aspect of the present invention, primarily incudes a controller 11, an operator 12, a display 13, an image processor 14, a communicator 18, a system path setter 21, a user path setter 22, a storage folder path generator 23, a user identification information setter 24, a data storage executor 25, and a storage 50.

The image processor 14 primarily includes an image inputter 15, an image former 16, and an image outputter 17.

The storage 50 of the image forming apparatus stores various types of data such as image data input by the user, and it is assumed that, in a storage area of the storage 50 that stores the image data, or the like, a plurality of folders is previously set and is associated with each other by a predetermined hierarchical structure.

The storage destination folder storing the data input by the user, described below, is any of the folders.

The controller 11 is a unit that controls the operation of each component, such as an operator and an image processor, and is primarily implemented by a microcomputer including a CPU, a ROM, a RAM, an I/O controller, a timer, etc.

The CPU organically operates various types of hardware based on a control program previously stored in the ROM, or the like, to execute an image forming function, a storage folder generation function, or the like, which is one aspect of the present invention.

The system path setter 21, the user path setter 22, the storage folder path generator 23, and the user identification information setter 24, included in the above-described components, are functional blocks whose processes are executed by the CPU based on predetermined programs.

The operator 12 is a unit with which the user of the image forming apparatus inputs information and is an input device for performing predetermined input operations to operate the image forming apparatus. For example, the operator 12 is a unit to input information such as characters and provide an input to select a function, and uses a keyboard, a mouse, a touch panel, or the like.

Examples of the keys operated by the user include an operation start key, a function selection key, and a setting key.
For example, the user performs an input operation with the touch panel or the start key for a reading operation so as to execute a copying function, a system path setting function, a user registration function, etc.

In particular, with the system path setting function, an input operation with the touch panel or a predetermined selection key is performed to set and enter system path information (default destination folder), etc. With the user registration function, an input operation with the touch panel or a predetermined selection key is performed to set and enter information such as a user ID, initial storage destination information (storage destination folder path) of the user, etc.

The display 13 is a unit that presents information and presents, for example, the information needed to execute each function or a result of execution of a function in order to notify it to the user. For example, an LCD, an organic EL display, or the like, is used as the display 13, and when a touch panel is used as the operator 12, the display 13 and the touch panel are superimposed on each other.

The display 13 uses characters, symbols, graphics, images, icons, animations, moving images, and the like, to present, for example, the information needed to set setting items used for printing, and the like, of the image forming apparatus and to execute the document reading function, and the like, and an operation screen for a selected function.

In particular, according to one aspect of the present invention, as described below, the display 13 presents a setting screen for the system path information, an entry screen for the user registration information, a display screen for the storage destination folder, etc.

As described below, the display 13 also presents a diagrammatic screen using a hierarchical structure to indicate the relationship of the plurality of folders up to the storage destination folder.
The diagrammatic screen is used for initially setting a custom destination described below.
For example, the user uses the operator 12 to select the folder as the storage location for storing data from the plurality of folders presented on the diagrammatic screen so as to initially set the custom destination.

The image processor 14 is a unit that executes an image forming function, which is a primary function of the image forming apparatus, and primarily includes the image inputter 15, the image former 16, and the image outputter 17.

Primarily, the image inputter 15 is a unit that inputs predetermined image data, the image former 16 is a unit that converts the input image data into information that can be printed or the like, and the image outputter 17 is a unit that outputs formed print information, or the like, onto a print sheet, etc.

The image inputter 15 is a unit that inputs the image data on a document containing an image, character, graphic, or the like, and is for example a unit that reads a document placed on a document table, or the like.

A scanner (reading device) that reads a document containing information is used as the image inputter 15.
The image forming apparatus 1 includes, to read a document, a document placement table (document table) on which a document is placed and a document cover that presses a document.
The image forming apparatus 1 may include an automatic document feeder (ADF) that has a plurality of documents placed thereon and automatically feeds and reads the documents one by one.
In this case, a scanner reads a document containing an image, or the like, and the storage 50 stores image data (input image data) on the document.

There are various methods for inputting image information.

For example, the image inputter 15 corresponds to an interface for connecting an external storage medium, such as a USB memory.
An electronic data file for the image information to be input may be stored in an external storage medium such as a USB memory, the USB memory may be connected to an input interface such as a USB terminal, the desired electronic data file stored in the USB memory may be read by a predetermined input operation with the operator 12, and the electronic data file may be stored as input image data in the storage 50.

For example, to print the input image data on a recording medium, the image former 16 typically performs a series of processes for charging, exposure, development, transfer, cleaning, static elimination, and fusion to form an image on the recording medium based on the input image data.

During the developing process, toner is supplied from a toner cartridge to a developing device and an electrostatic latent image formed on the surface of a charged photoconductive drum is developed to form a toner image corresponding to the electrostatic latent image. The toner image formed on the surface of the photoconductive drum is transferred onto the recording medium by a transfer device, and then the image is fixed to the recording medium due to heat applied by a fusing device.
The image former 16 converts the input image data into information in a transferable and displayable form.

The image outputter 17 is a unit that outputs the formed input image data and corresponds to, for example, a printer that prints information such as the input image data so as to print the input image data on the read document on a predetermined print sheet (sheet medium).

The output of the input image data includes not only printing but also storage of the input image data on a scanned document and fax transmission of the input image data on a scanned document.

The image output corresponds to, for example, storing the input image data on the scanned document in an external storage medium such as a USB memory, transmitting the input image data to the other information processing apparatus or server via a network such as the Internet, classifying and storing the input image data in a specific storage folder inside the image forming apparatus, and classifying and storing the input image data in a specific storage folder of the other information processing apparatus or server.

The communicator 18 is a unit that communicates information such as image data via a network and transmits and receives data to and from the other information processing apparatus or server.

For example, the communicator 18 receives electronic data files transferred from an information processing apparatus such as a PC, mobile terminal, or server.
The communicator 18 transfers the input image data generated by the image forming apparatus 1, which is one aspect of the present invention, to an external storage device (such as a USB memory) connected to the image forming apparatus 1 or transmits the input image data via a network to an information processing apparatus such as a personal computer or server that is owned by the user of the input document.

In a case where the communicator 18 transmits the image data, or the like, to the other information processing apparatus, it is assumed that the other information processing apparatus also includes a storage in which a plurality of folders is previously set and is associated with each other by a predetermined hierarchical structure and the storage destination folder storing the input image data is a folder previously set in the storage of the other information processing apparatus.

In this case, the communicator 18 designates a storage destination folder as a storage destination for the input image data and transmits the input image data, or the like, to the other information processing apparatus.
The image data transmitted from the image forming apparatus and received by the other information processing apparatus is stored in the storage destination folder included in the plurality of folders set in the storage of the other information processing apparatus.

Any existing communication network such as a wide area communication network, e.g., the Internet, or a LAN may be used as the network, and either wired or wireless communication may be used as a communication form.

The system path setter 21 is a unit that initially sets the system path information as path information up to the storage destination folder that is the storage location for storing the data.

The system path information is the initial path information that is common to all the users of the image forming apparatus and is the information indicating the hierarchical path up to a folder that may be used as a storage location by all the users.
The system path information is also referred to as “system default” or “default destination folder path”.

The system path information (system default) is used as the storage destination folder path indicating the location of the folder for storing the input image data.

For example, only the system path information (system default) is set as the storage destination folder path, or the path information combining the system path information (system default) and the custom destination described below is set as the storage destination folder path.

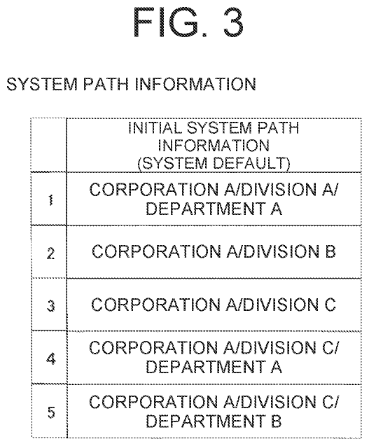

For example, as illustrated in FIG. 3, the system path information (system default) is set to “corporation A/division A/department A”. As described below, the symbol “I” represents a hierarchical separator in the hierarchical structure of folders, in which “corporation A” refers to a top-level folder, “division A” refers to a folder immediately below “corporation A”, and “department A” refers to a folder below “division A”.

In principle, an administrator of the image forming apparatus sets the system path information.

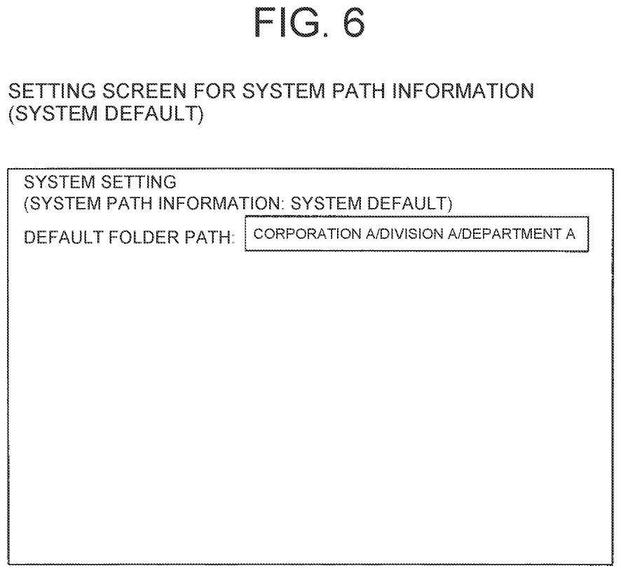

For example, as described below, the setting screen for the system path information is presented so that the administrator directly enters the character string forming the system path information.
Alternatively, in order to facilitate an input operation, the hierarchical structure of storage folders of the image forming apparatus is presented in the form of a diagram by using icons, or the like, and an icon of the desired folder is selected so that the system path information (system default) is set. The system path information may be set by an authorized user with the agreement of a plurality of users using the image forming apparatus.
A specific example of the system path information is described below with reference to FIGS. 3, 6, and the like.

The user path setter 22 is a unit that initially sets, for each user, the initial path information up to the storage destination folder that is the storage location for storing the input data.

Specifically, the initial storage destination information, which is part or all of the storage destination folder path indicating the hierarchical structure up to the storage destination folder previously set by the user, is set for each user.

The initial storage destination information sets the initial value of the path information up to the storage destination folder in which the image data input to the image forming apparatus by the user is to be stored.

As described below, the initial storage destination information is selected by the user or the administrator after the entry screen for the user registration information is presented.

The folder at the storage location where the image data is to be stored by the user is referred to as “storage destination folder”, and the path information indicating the hierarchical structure up to the storage destination folder is referred to as “storage destination folder path” or “storage path information”.

By using the initial storage destination information selected by the user, the storage folder path generator 23 described below generates the storage destination folder path (storage path information).

When the image data related to the user is input, the input image data related to the user is, in principle, stored in the storage destination folder specified by the storage destination folder path.

For example, only the above-described system path information (system default) may be selected as the initial storage destination information.

As described below, when only the system path information is selected as the initial storage destination information, the folder specified by the path set in the system path information is generated as a storage destination folder and is set as the storage destination for the image data.

Alternatively, the information including the system path information (system default) and the user ID may be selected as the initial storage destination information.

The user ID is one of the initially set user identification information, and it is assumed that the plurality of folders previously set in the storage includes an ID folder that may identify the user ID.
As described below, when the information including the system path information (system default) and the user ID is selected as the initial storage destination information, the folder (ID folder) specified by the path having the user ID added to the system path information is generated as a storage destination folder and is set as the storage destination of the image data.

The information including the system path information (system default) and user initial path information (custom destination) may be selected as the initial storage destination information.

The user initial path information (custom destination) is user-specific path information that is initially set by each user.
When the user initial path information (custom destination) is selected as the initial storage destination information, the custom destination is included in the initial path information up to the storage destination folder. The custom destination may be set to include the path information indicating the hierarchical structure from the ID folder, with which the initially set user ID is identifiable, up to the storage destination folder.

As described below, when the information including the system path information (system default) and the user initial path information (custom destination) is selected as the initial storage destination information, the folder specified by the path having the custom destination added to the system path information is generated as a storage destination folder and is set as the storage destination of the image data.

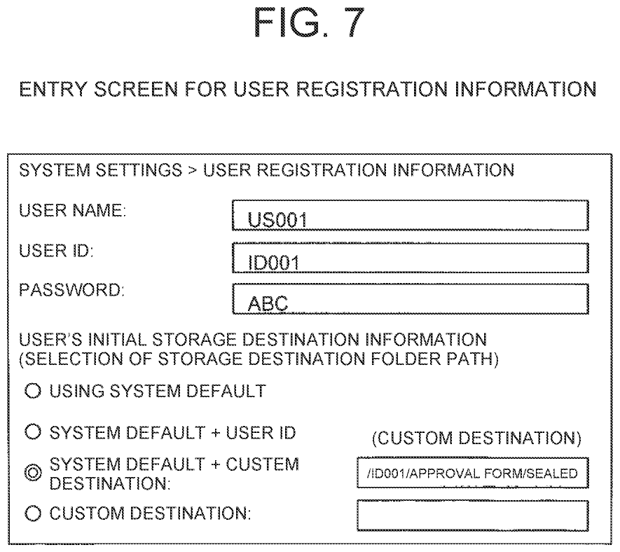

A specific example of selecting the initial storage destination information is described below with reference to FIG. 7, and the like.

The storage folder path generator 23 is a unit that uses the initial storage destination information selected by the user to generate the path information (storage destination folder path) indicating the hierarchical structure up to the storage destination folder in which the data is to be stored by the user.

According to one aspect of the present invention, in particular, the storage destination folder path including the initial path information, which is initially set by the user path setter 22, as part of the hierarchical structure is generated.
The storage destination folder path specifies the location of the folder in which the image data is to be stored by the user.

For example, when the initial storage destination information selected by the user includes only the system path information (system default), the system path information is generated as a storage destination folder path.

When the initial storage destination information includes the system path information (system default) and the user initial path information (custom destination), the path information combining the system path information and the custom destination is generated as a storage destination folder path.

The user identification information setter 24 is a unit that initially sets user identification information including a user ID.

The user identification information is information for identifying the user who uses the image forming apparatus and for performing an authentication process for the user and includes information such as a user name, a user ID, or a password.
It is assumed that the user identification information is stored as one piece of user registration information described below.

When the user uses the image forming apparatus to execute an image reading function, a copying function, etc., the user first enters the same user identification information (e.g., the user ID and the password) as that stored in the initial settings so as to execute a user authentication process.

During the user authentication process, the stored user identification information is checked against the entered user identification information and, when the user authentication is successful, the execution of the copying function, and the like, is enabled.

The data storage executor 25 is a unit that performs the process to store the input data in a predetermined storage destination folder.

In particular, when the data related to the user is input to the image forming apparatus by the user, the data input by the user is stored in the storage destination folder by using the storage destination folder path generated by the storage folder path generator 23.
For example, the user's image data scanned by the scanner is stored in the storage destination folder specified by the storage destination folder path generated from the path information set in the initial storage destination information by the user.

The storage 50 is a unit that stores information and programs needed to execute each function of the image forming apparatus that is one aspect of the present invention, and a semiconductor storage device such as a ROM, a RAM, or a flash memory, a storage device such as an HDD or an SSD, or other storage media is used as the storage 50.

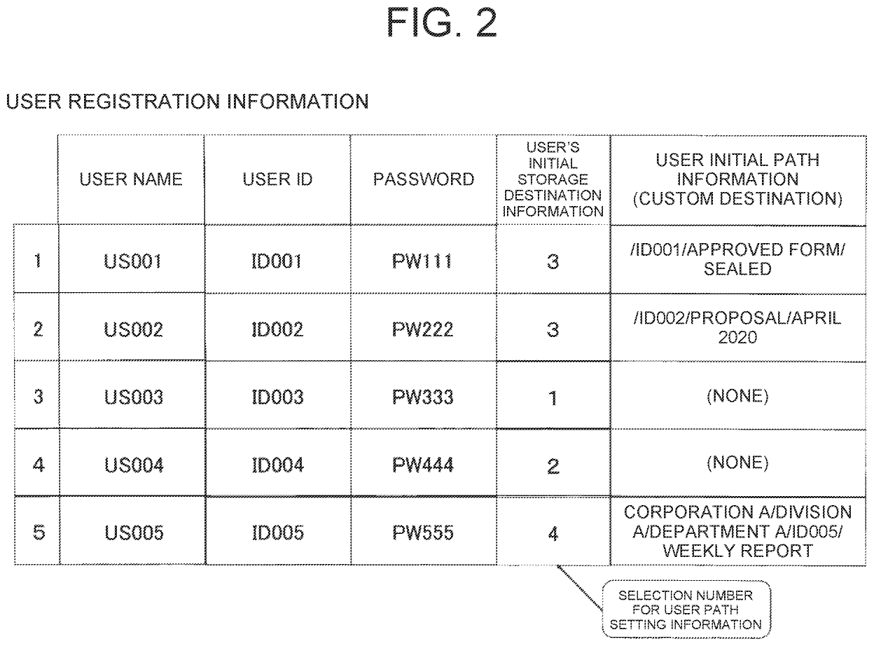

The storage 50 stores, for example, input image data 51, user registration information 52, system path information 53, user path setting information 54, and storage destination information 55.
FIGS. 2 to 4 and FIG. 10 are explanatory diagrams of information stored in the storage 50 according to an embodiment.

Input Image Data 51

The input image data 51 is image data input by the image inputter 15 as described above.
The input image data 51 is stored in, for example, a storage folder set in a hard disk drive (HDD) included in the storage 50 of the image forming apparatus, but when the path information (storage destination folder path) up to the storage destination of the image data is initially set by the user, the image data is stored in the storage destination folder whose location is specified by the path information.

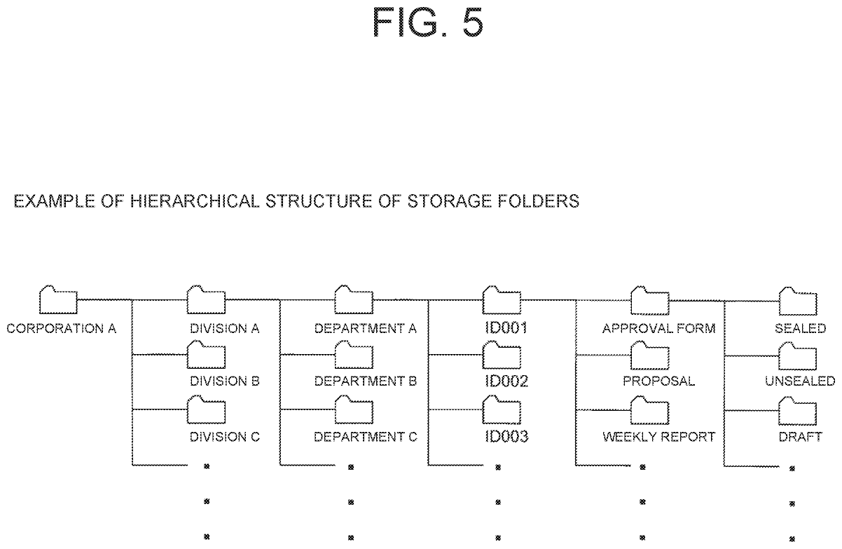

FIG. 5 is an explanatory diagram of the hierarchical structure of storage folders set in the hard disk drive (HDD) according to an embodiment. It is assumed that a plurality of storage folders having a hierarchical relationship is previously set, as illustrated in FIG. 5.

For example, “corporation A” is set as the folder in a top level of the hierarchy, and “division A”, “division B”, “division C”, and the like, are set as folders in a second level of the hierarchy below “corporation A”.

Furthermore, “department A”, “department B”, “department C”, and the like, are set as folders in a third level of the hierarchy, and “ID001”, “ID002”, “ID003”, and the like, which are ID folders for the respective users belonging to the respective departments are set as folders in a fourth level of the hierarchy immediately below “department A”, “department B”, and “department C”.

It is assumed that the user IDs are assigned as the folder names of the ID folders, but information such as user names that may identify the users may also be assigned.

In lower levels of the hierarchy below the ID folders of the respective users, the user's own folders are set with, for example, the names for classifying the documents.

In FIG. 5, “approval form”, “proposal”, “weekly report”, and the like, are set as folders in a fifth level of the hierarchy immediately below the folder “ID001” of the user with the user ID of ID001, and “sealed”, “unsealed”, “draft”, and the like, are set as folders in a sixth level of the hierarchy below the folder “approval form”.

It is assumed that, according to the embodiment below, the symbol “I” is used as a hierarchical separator to indicate the hierarchical structure of the folders and the hierarchical structure of the folders is represented in a form such as “(folder name 1)/(folder name 2)/(folder name 3)/(folder name 4)”.

It is assumed that the folder on the left of the symbol “I”, which is a hierarchical separator, represents an upper-level folder, and the folder on the right of the symbol “I” represents a lower-level folder.
Other symbols may be used as a hierarchical separator. The form indicating the hierarchical structure of the folders does not necessarily need to be represented as the above-described form, and any form may be used as long as the uniform form of representation is used by a number of image forming apparatuses, servers, and the like, in use. A uniform form of representation may be determined and used by the same company or organization.

The hierarchical structure of the storage folders illustrated in FIG. 5 is used for the purpose of describing the embodiment below, and the hierarchical structure and the folder names are not limitations.

Unique hierarchical structure and folder names may be set depending on the company, department, or the like, in which the image forming apparatus is installed.
In addition to the user ID and the name for classifying the document, any unique character string defined by the user may be used as a folder name.

User Registration Information 52

The user registration information 52 is information about a user who uses the image forming apparatus and is entered by the user.
FIG. 2 illustrates the user registration information 52 according to an embodiment.
The user registration information 52 illustrated in FIG. 2 includes the user name, the user ID, the password, the user's initial storage destination information, and the user initial path information (custom destination). The user name, the user ID, and the password are information (user identification information) for identifying the user, and for example the user ID and the password are used during the user authentication process when the user intends to use the image forming apparatus.
Other personal information may be stored as information (user identification information) for identifying the user.

The user's initial storage destination information is information for the user to initially set the location of the storage destination folder in which the image data is to be stored and is a selection number of the user path setting information 54 described below as illustrated in FIG. 2.

The user initial path information (custom destination) is information indicating the location (path information) of the storage destination folder set and entered by the user and is entered by the user during the initial settings of the user registration information 52.
The user's initial storage destination information and the user initial path information determine the path information (storage destination folder path) up to the storage destination folder designated by the user.

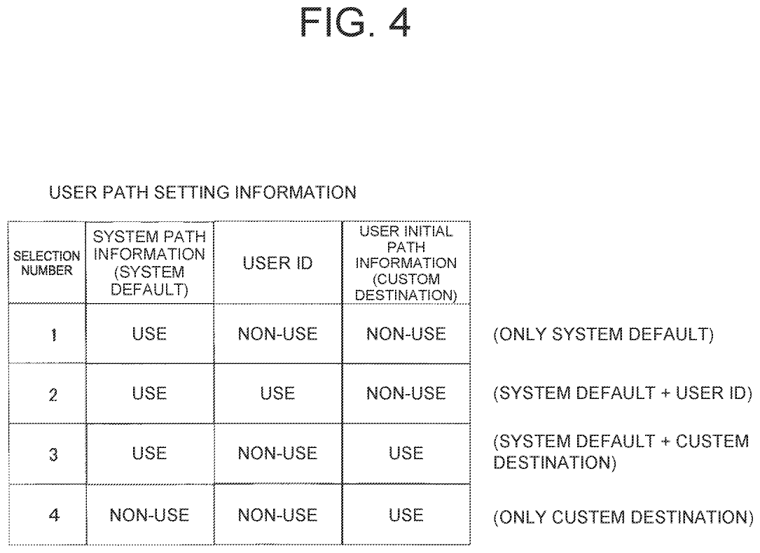

It is assumed that, according to the embodiment below, the user's initial storage destination information includes four types of information, as illustrated in FIG. 4 below, and any of the four types of information is selected by the user.

For example, as illustrated in FIGS. 4 and. 7, the user's initial storage destination information includes four types, i.e., the information including only the system path information (system default) with selection number 1, the information including the system path information (system default) and the user ID with selection number 2, the information including the system path information (system default) and the custom destination with selection number 3, and the information including only the custom destination with selection number 4.

The user registration information 52 illustrated in FIG. 2 includes user registration information on five persons. For example, for the user with the user name of US003, the initial storage destination information is set to 1, and no user initial path information (custom destination) is set. This means that the storage destination folder path set by the user with the user name of US003 is generated only from the system path information.

For the user with the user name of US004, the initial storage destination information is set to 2, and no user initial path information (custom destination) is set.

This means that the storage destination folder path set by the user with the user name of US004 is generated from the combination of the system path information and the user ID (ID004). In this case, it is assumed that the ID folder having the user ID assigned as its folder name is prepared.

For the user with the user name of US001, the initial storage destination information is set to 3, and “/ID001/approval form/sealed” is set as the user initial path information (custom destination).

This means that the storage destination folder path set by the user with the user name of US001 is generated from the combination of the system path information and the custom destination.

For the user with the user name of US005, the initial storage destination information is set to 4, and “corporation A/division A/department A/ID005/weekly report” is set as the user initial path information (custom destination).

This means that the storage destination folder path set by the user with the user name of US005 is generated from only the custom destination.

The user registration information 52 causes the display 13 to present an entry screen for the user registration information 52 so that the user makes an entry.

FIG. 7 is an explanatory diagram of the entry screen for the user registration information 52 presented on the display 13 according to an embodiment.
In FIG. 7, there are an entry field for the user identification information, a selection field for the user's initial storage destination information (selection of the storage destination folder path), and an entry field for the custom destination.
The selection field for the initial storage destination information presents the four types of path candidate information described above, such as “using the system default”, and a circle for selection is presented on the left side of each piece of information.
By selecting the circle, the desired initial storage destination information is selected.

On the entry screen illustrated in FIG. 7, the user enters the user name, the user ID, and the password in the respective boxes on the right side of the area where the user identification information (the user name, the user ID, and the password) is presented.

The user selects the circle corresponding to the desired initial storage destination information in the selection field for the initial storage destination information.
When “system default+custom destination” or “custom destination” is selected, the user enters the path information in the entry field for the custom destination.

In the case of a long character string that serves as the path information for the custom destination, for example, the diagrammatic screen for the hierarchical structure of storage folders illustrated in FIG. 5 is displayed and the location of the folder in the lowest level of the hierarchy as the custom destination is selected so that the custom destination may be entered. The location of the folder in the lowest level of the hierarchy as the custom destination is the storage destination folder in which the image data is stored.

This may make it easy to enter the custom destination and may prevent incorrect entry.

FIG. 7 illustrates a state where, as the user registration information 52, the user identification information “US001, ID001, and ABC” has been entered, “system default+custom destination” has been selected, and “/ID001/approval form/sealed” has been entered as the custom destination.

Here, the folder with the name “sealed” is the storage destination folder where the image data input by the user is to be stored.

In a case where the user actually uses the image forming apparatus so as to execute a desired function, input the image data, and store the image data in a desired folder, it is preferable to perform a user authentication process in the image forming apparatus before the function is executed.

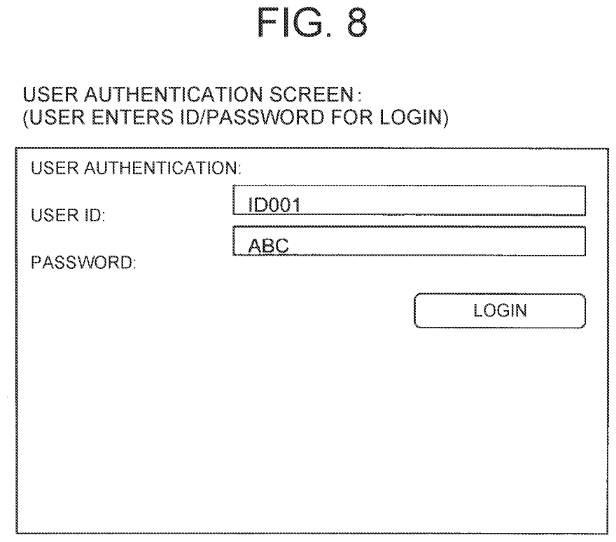

During the user authentication process, for example, the user ID and the password stored as the user registration information may be used.
FIG. 8 is an explanatory diagram of an entry screen for user authentication information presented on the display 13 according to an embodiment.
FIG. 8 illustrates a state where, as the user authentication information, “ID001” has been entered as the user ID and “ABC” has been entered as the password.
Subsequently, a display area “login” is selected, and thus the entered user ID and the entered password are compared with the user ID and the password in the user registration information already stored so that user authentication is performed.
After the user authentication is successfully executed, the functions of the image forming apparatus may be enabled.

System Path Information 53

The system path information 53 is information set by the system path setter 21 as described above.
A common path often used by a large number of users of the image forming apparatus as path information for the storage destination of image data is set as the system path information (system default) 53, and the system path information 53 may be previously set, for example, for each specific department of a company.

FIG. 3 illustrates the system path information 53 according to an embodiment.

FIG. 3 illustrates the five pieces of system path information (system default) 53.
In FIG. 3, for example, as for “corporation A/division A/department A”, which is first system path information (system default), a common path up to the folder in which the users belonging to “department A” store image data is previously set as the initial system path information.
As for “corporation A/division B”, which is second system path information (system default), a common path up to the folder in which the users belonging to “division B” store image data is previously set as the initial system path information.

As described above, when the user selects the selection number including the system path information (system default) as the user's initial storage destination information, the system path information is used for the storage destination folder path for the user.

When only the one piece of system path information 53 is set and stored, the system path information 53 is used.
As illustrated in FIG. 3, when the plurality of pieces of system path information 53 is set and stored, the one piece of system path information 53 selected by the user among the plurality of pieces of system path information 53 is used.

The system path information 53 causes the display 13 to present the setting screen for the system path information (system default) so that the administrator makes an entry.

FIG. 6 is an explanatory diagram of the setting screen for the system path information presented on the display 13 according to an embodiment.
In FIG. 6, the system path information (system default) to be set by the administrator is entered in the box on the right side of the area where the default folder path is presented.
FIG. 6 illustrates a state where “corporation A/division A/department A” has been entered as the system path information (system default).

In the case of a long character string that serves as the system path information, for example, the diagrammatic screen for the hierarchical structure of storage folders illustrated in FIG. 5 is displayed and the location of the folder in the lowest level of the hierarchy as the system path information is selected so that the system path information may be entered. This may make it easy to enter the system path information and may prevent incorrect entry.

User Path Setting Information 54

The user path setting information 54 is previously stored information corresponding to a plurality of initial storage destination information that is selectable by the user.
As described above, the storage destination folder path is generated using the information associated with the selection number of the initial storage destination information selected by the user.

FIG. 4 illustrates the user path setting information 54 according to an embodiment.

FIG. 4 illustrates the information corresponding to four types of initial storage destination information, and the user may select the desired initial storage destination information from the four types of selection patterns (variations).
In FIG. 4, the user path setting information 54 includes the system path information (system default), the user ID, and the user initial path information (custom destination), and the combination of used/unused information is indicated for each selection number. The combination of used/unused information is indicated by “use” and “non-use”.

For example, the selection number 1 indicates that only the system path information (system default) is used and the user ID and the user initial path information (custom destination) are not used.

That is, when the initial storage destination information with the selection number 1 is selected, the storage destination folder path is generated using only the system default.

The selection number 2 indicates that the system path information (system default) and the user ID are used and the user initial path information (custom destination) is not used.

When the initial storage destination information with the selection number 2 is selected, the storage destination folder path is generated using the system default and the user ID.
In this case, with the hierarchical structure of the storage folders illustrated in FIG. 5, the path having the user ID added to the end of the system default path information is generated as a storage destination folder path.

The selection number 3 indicates that the system path information (system default) and the user initial path information (custom destination) are used and the user ID is not used.

When the initial storage destination information with the selection number 3 is selected, the storage destination folder path is generated using the system default and the custom destination.
In this case, with the hierarchical structure of the storage folders illustrated in FIG. 5, the path having the custom destination added to the end of the system default path information is generated as a storage destination folder path.

The selection number 4 indicates that only the user initial path information (custom destination) is used and the system path information (system default) and the user ID are not used.

When the initial storage destination information with the selection number 4 is selected, the storage destination folder path is generated using the custom destination entered by the user.
In this case, with the hierarchical structure of the storage folders illustrated in FIG. 5, the path including only the custom destination is generated as a storage destination folder path.

With the previously set user path setting information 54 illustrated in FIG. 4, the user may select the selection number of the desired initial storage destination information to set the storage destination folder path desired by the user, and therefore it is possible to increase the variations (the number of selections) of storage destination folder paths as well as the fixed system path information and the path information using the user ID.

The user path setting information 54 includes not only the four types illustrated in FIG. 4 but also other types of information previously set in consideration of the hierarchical structure of storage folders, folder names, etc.

Storage Destination Information 55

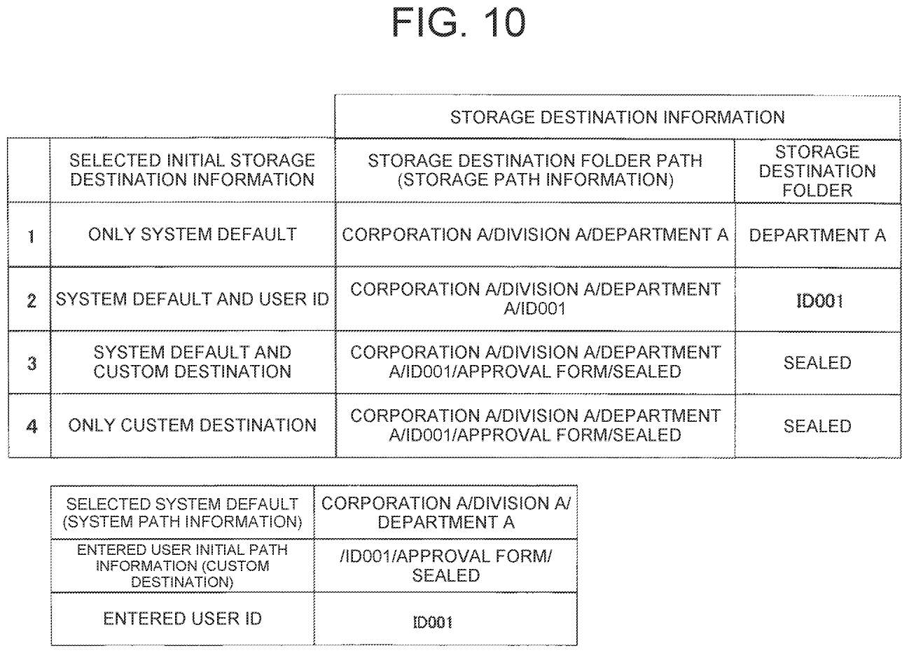

The storage destination information 55 is information storing the storage destination folder path generated by the storage folder path generator 23.
FIG. 10 is an explanatory diagram of the storage destination information 55 according to an embodiment.
The storage destination information 55 illustrated in FIG. 10 is storage destination information generated for each selected initial storage destination information according to an embodiment.
As illustrated in FIG. 10, the storage destination information 55 includes the storage destination folder path and the storage destination folder.
Here, it is assumed that the selected system default is “corporation A/division A/department A”, the custom destination, which is the user initial path information entered by the user, is “/ID001/approval form/sealed”, and the user ID is “ID001”.

In FIG. 10, when the initial storage destination information selected by the user is only “system default”, for example, “corporation A/division A/department A”, which is a system default, is set as a storage destination folder path, and the storage destination folder where the image data is actually stored is the folder with the name “department A”.

In FIG. 10, when the initial storage destination information selected by the user is “system default and user ID”, for example, the path information combining “corporation A/division A/department A” and the user ID “ID001” is set as a storage destination folder path, and the storage destination folder where the image data is actually stored is the ID folder with the name “ID001”.

In FIG. 10, when the initial storage destination information selected by the user is “system default and custom destination”, for example, the path information combining “corporation A/division A/department A” and the custom destination “ID001/approval form/sealed” is set as a storage destination folder path, and the storage destination folder where the image data is actually stored is the folder with the name “sealed”.

In FIG. 10, when the initial storage destination information selected by the user is only “custom destination”, for example, when “corporation A/division A/department A/ID001/approval form/sealed” has been entered as a custom destination by the user, the custom destination is set as a storage destination folder path and the storage destination folder where the image data is actually stored is the folder with the name “sealed”.

Although the storage destination information 55 illustrated in FIG. 10 includes the storage destination folder path and the storage destination folder for the sake of description, the storage destination information 55 may store only the storage destination folder path as the name of the storage destination folder may be identified by the storage destination folder path.

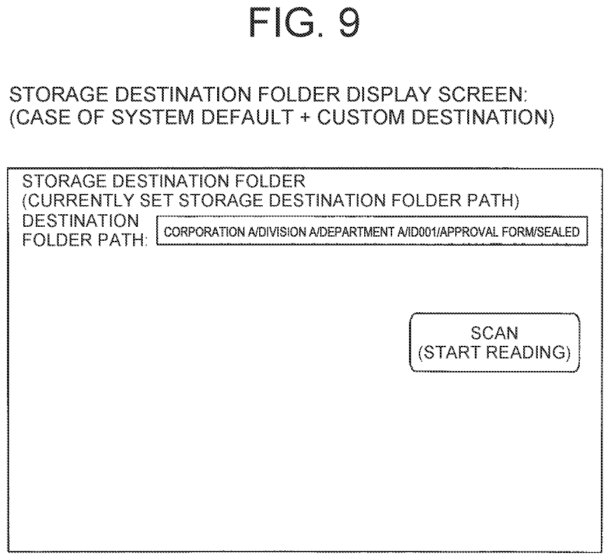

FIG. 9 is an explanatory diagram of a display screen for the storage destination folder presented on the display 13 according to an embodiment. FIG. 9 illustrates the storage destination folder path when “system default+custom destination” has been selected on the entry screen for the user registration information of FIG. 7.

Here, the system default is “corporation A/division A/department A”, the custom destination is “/ID001/approval form/sealed”, and the storage destination folder path generated by combining the system default and the custom destination is “corporation A/division A/department A/ID001/approval form/sealed”.
If the presented storage destination folder path designates the storage destination folder intended by the user, for example, the user selects a display area “scan” so that a document reading process starts.

Embodiment of Initial Setting Process of Storage Folder

### First Embodiment: Case of Storing One System Default

Here, a description is given of the case of storing one piece of system path information (system default).
It is assumed that, in the image forming apparatus, the setting of the system path information and the settings of the user registration information are requested so as to initially set the storage destination folder.
In principle, the setting of the system path information is requested by the administrator, and the settings of the user registration information are requested by each user.

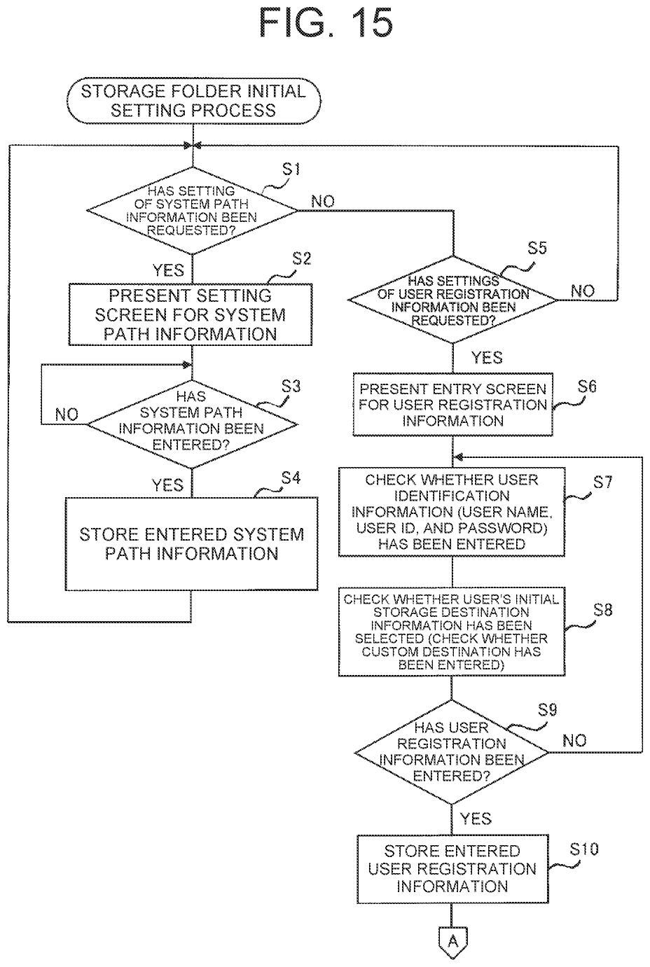

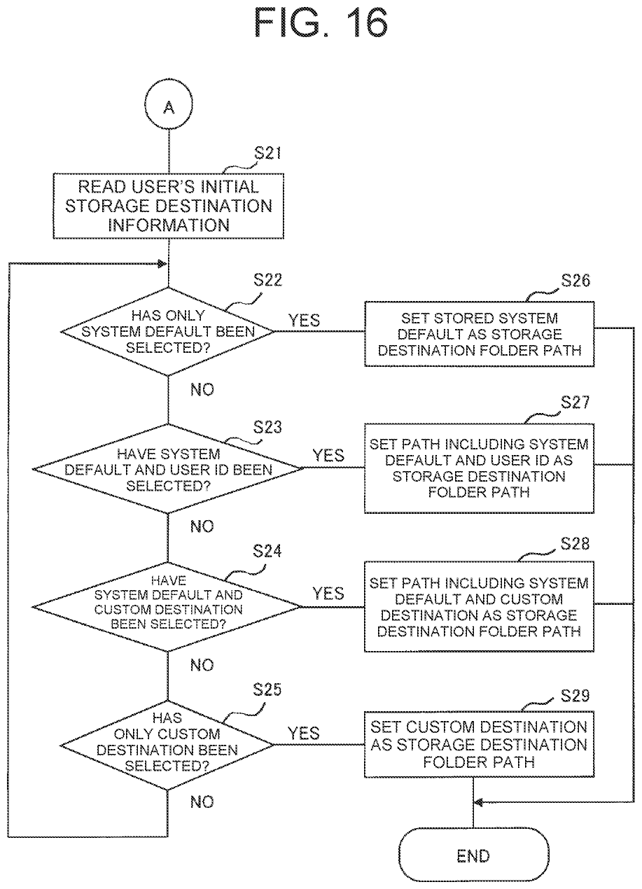

FIGS. 15 and 16 are flowcharts of an initial setting process of a storage destination folder in the image forming apparatus according to an embodiment.

At Step S1 of FIG. 15, the controller 11 checks whether a request for setting the system path information has been input. When the setting of the system path information has been requested, the process proceeds to Step S2. When the setting of the system path information has not been requested, the process proceeds to Step S5.
At Step S5 of FIG. 15, the controller 11 checks whether a request for setting the user registration information has been input. When the settings of the user registration information have been requested, the process proceeds to Step S6. When the settings of the user registration information have not been requested, the process returns to Step S1.

At Step S2, the display 13 presents the setting screen for the system path information.

Here, for example, the display screen illustrated in FIG. 6 is presented. The administrator enters the system path information in a predetermined entry box on the setting screen for the system path information.
For the system path information, a character string may be directly entered, or the hierarchical structure of the storage folders illustrated in FIG. 5 may be presented in the form of a diagram so that the folder in the lowest level to be set as the system path information may be selected. This selection causes the path information up to the folder in the lowest level to be presented in the entry box for the system path information.
After the entry is finished, the administrator selects a setting end key (not illustrated) or a display area (not illustrated) for ending the setting.

At Step S3, when the system path information has been entered and the entry has been finished, the process proceeds to Step S4. When the system path information has not been entered, Step S3 is repeatedly executed.

At Step S4, the entered system path information 53 is stored in the storage 50. Then, the process returns to Step S1.
In FIG. 15, it is assumed that only one piece of system path information is set and stored.

At Step S6, the display 13 presents the entry screen for the user registration information.

Here, for example, the display screen illustrated in FIG. 7 is presented.
The user enters the user identification information (the user name, the user ID, and the password) in the predetermined boxes on the entry screen for the user registration information.
Further, the user selects the user's initial storage destination information from four options.
FIG. 7 illustrates a state where “system default+custom destination” has been selected.

In the entry box for the custom destination on the right side of “system default+custom destination”, the path information up to the storage destination folder where the image data is to be stored is entered, excluding the system default part.

For the custom destination, a character string may be directly entered, or the hierarchical structure of the storage folders illustrated in FIG. 5 may be presented in the form of a diagram so that the folder in the lowest level to be set as the custom destination may be selected. This selection causes the path information excluding the system default part to be presented in the entry box for the custom destination.

Similarly, when “custom destination”, which is a fourth option, is selected, the path information up to the storage destination folder where the image data is to be stored is entered in the entry box for the custom destination on the right side of “custom destination”.

In this case, as the system default is not used, the path information from the top-level folder up to the storage destination folder is entered.
After the entry is finished, the setting end key (not illustrated) or the display area (not illustrated) for ending the setting is selected.

At Step S7, it is checked whether the user identification information (the user name, the user ID, and the password) has been entered.

At Step S8, it is checked whether the user's initial storage destination information has been selected and, if needed, it is checked whether the custom destination has been entered.
At Step S9, when the user identification information and the user's initial storage destination information have been entered and all the entry items of the user registration information have been entered, the process proceeds to Step S10. When all the entry items of the user registration information have not been entered, the process returns to Step S7 to wait for the user registration information to be entered.

At Step S10, the entered user registration information 52 is stored in the storage 50. Then, the process proceeds to Step S21 in FIG. 16.

At Step S21 of FIG. 16, the user's initial storage destination information is read from the storage 50.

At Steps S22 to S25, it is checked whether any of the four options has been selected as the user's initial storage destination information.

When only “system default” has been selected at Step S22, the process proceeds to Step S26. When only “system default” has not been selected, the process proceeds to Step S23.

When “system default+user ID” has been selected at Step S23, the process proceeds to Step S27. When “system default+user ID” has not been selected, the process proceeds to Step S24.
When “system default+custom destination” has been selected at Step S24, the process proceeds to Step S28. When “system default+custom destination” has not been selected, the process proceeds to Step S25.
When only “custom destination” has been selected at Step S25, the process proceeds to Step S29. When only “custom destination” has not been selected, the process returns to Step S22.

At Step S26, the system default stored in the storage 50 is set as the storage destination folder path, and the process is terminated.

At Step S27, the path including the system default and the user ID stored in the storage 50 is set as the storage destination folder path, and the process is terminated.
At Step S28, the path including the system default and the custom destination stored in the storage 50 is set as the storage destination folder path, and the process is terminated.
At Step S29, the custom destination stored in the storage 50 is set as the storage destination folder path, and the process is terminated.

Although not illustrated in FIG. 16, after the storage destination folder path is set, the display 13 may present the set storage destination folder path so that the user may confirm whether the set storage destination folder path is the one intended by the user.

When the storage destination folder path is not the one intended by the user, the settings of the user registration information may be started over again. The set storage destination folder path may be stored in the storage 50 for each user in association with the user identification information.

The storage destination folder indicated by the set storage destination folder path is the initial storage folder for storing the image data by the user who has made the initial settings.

Afterward, when the user stores the input image data, the input image data is stored in the above-described storage destination folder initially set by the user unless the storage destination folder is explicitly changed.

As described above, the user may select any of the prepared four types of initial storage destination information to set any of the four types as the storage destination folder path, and therefore the variations (the number of selections) of the storage destinations of the image data may be increased, not only the fixed system default and user ID but also in the combination with the custom destination that is initially and uniquely set by the user. Storing the storage destination folder path uniquely set by the user may reduce the frequency of changing the storage destination folder, which is set using a fixed system default or user ID, to the user's desired folder each time and to reduce the user's operational burden when setting and entering the storage location of image data.

Furthermore, as each user may uniquely set the custom destination, the user may change the custom destination to flexibly and easily change the setting of the initial storage destination of the image data to a frequently used storage destination folder, or the like, depending on the usage condition, or the like, of the image forming apparatus.

### Second Embodiment: Case of Storing Plurality of System Defaults

Here, a description is given of the case of storing a plurality of pieces of system path information (system defaults).
When a plurality of pieces of system path information (system defaults) is set in the image forming apparatus, the user selects one desired piece of system path information from the plurality of pieces of system path information. For example, when the five pieces of system path information is stored as illustrated in FIG. 3, the user selects the desired system path information from these pieces of system path information.

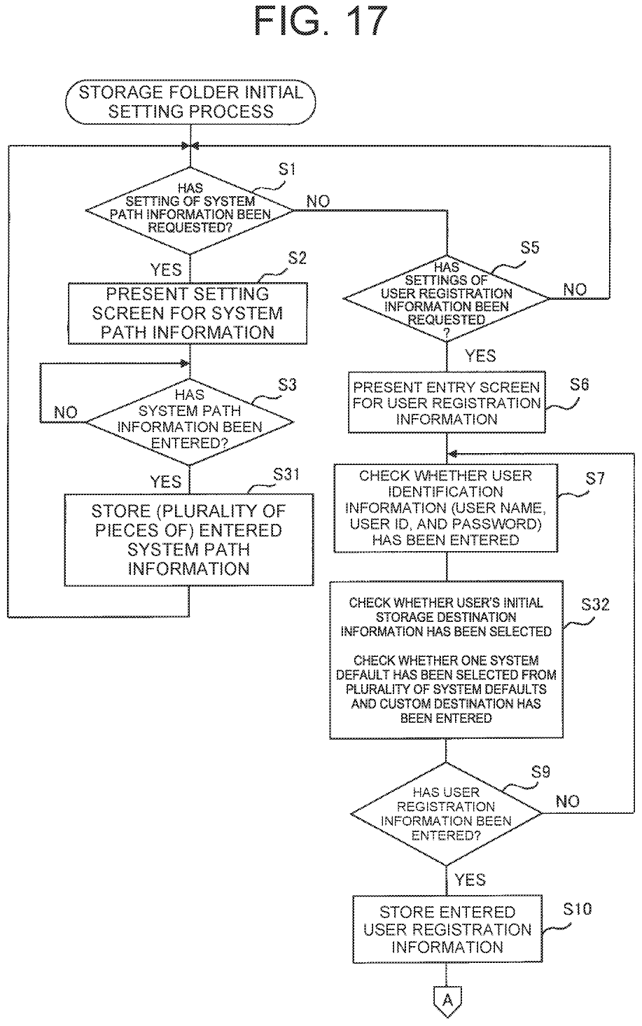

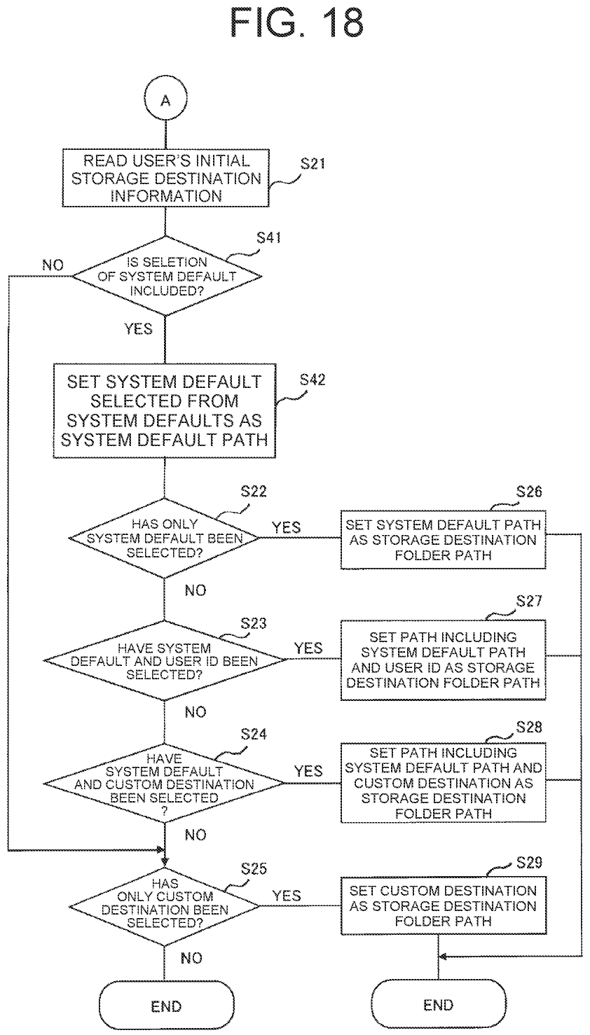

FIGS. 17 and 18 are flowcharts of the initial setting process of the storage destination folder according to another embodiment.

In FIGS. 17 and 18, the same numbers as those in FIGS. 15 and 16 are applied to the steps for performing the same processes as those illustrated in FIGS. 15 and 16 above.

The same processes as those at Steps S1 to S5 except for Step S4 in FIG. 15 are performed in FIG. 17.

Specifically, at Step S1 of FIG. 17, it is checked whether a request for setting the system path information has been input. When the setting of the system path information has been requested, the process proceeds to Step S2. At Step S5 of FIG. 17, it is checked whether a request for setting the user registration information has been input. When the settings of the user registration information have been requested, the process proceeds to Step S6. When the settings of the user registration information have not been requested, the process returns to Step S1.

At Step S2, the display 13 presents the setting screen for the system path information (system default).

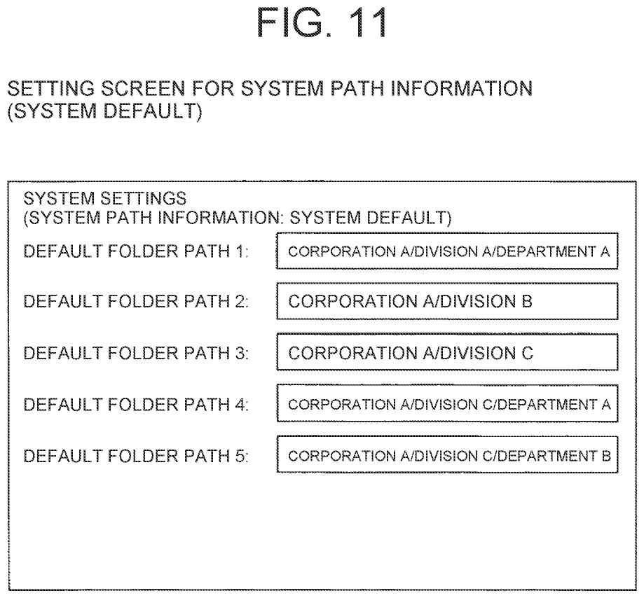

The administrator enters the system path information in a predetermined entry box on the setting screen for the system path information.
If second system path information is to be entered after first system path information is entered in a first entry box, for example, a display area (not illustrated) indicating information addition is selected so that a second entry box is presented, in which the system path information may be entered.
The administrator enters the second system path information in the second entry box presented.
Furthermore, if three or more pieces of system path information are to be entered, the same operation is repeatedly performed to present a new entry box in which system path information may be entered so that the plurality of pieces of system path information are entered.
When the plurality of pieces of system path information is entered, for example, the display screen illustrated in FIG. 11 is presented.
Similarly, for the system path information, the hierarchical structure of the storage folders illustrated in FIG. 5 may be presented in the form of a diagram so that the folder in the lowest level to be set as the system path information may be selected.
After the entry is finished, the administrator selects a setting end key (not illustrated) or a display area (not illustrated) for ending the setting.

At Step S3, when the system path information has been entered and the entry has been finished, the process proceeds to Step S31. When the system path information has not been entered, Step S3 is repeatedly executed.

At Step S31, the plurality of pieces of entered system path information 53 is stored in the storage 50. Then, the process returns to Step S1.
In FIG. 17, it is assumed that the plurality of pieces of system path information is set and stored.

At Step S6, the display 13 presents the entry screen for the user registration information.

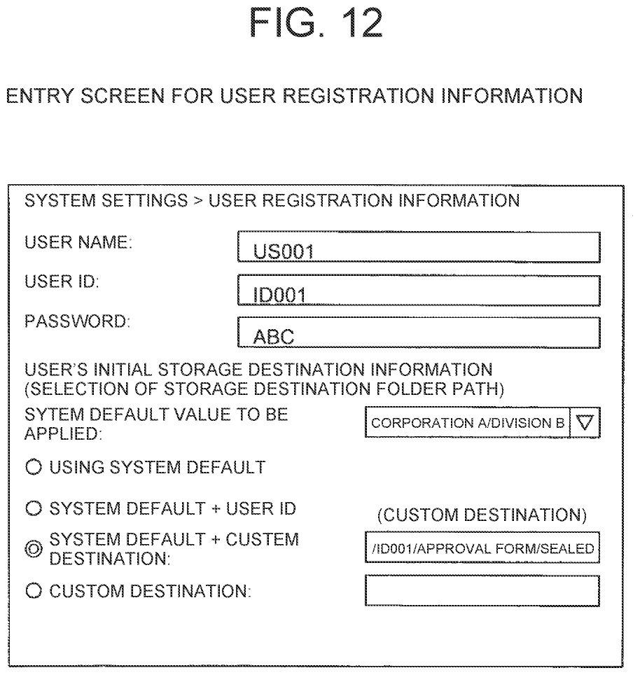

For example, the display screen illustrated in FIG. 12 is presented. In FIG. 12, unlike FIG. 7, as the plurality of pieces of system path information is set, a selection box is presented to select one piece of desired system path information (system default) among the plurality of pieces of system path information.

First, the user enters the user identification information (the user name, the user ID, and the password) in predetermined boxes on the entry screen for the user registration information.

Further, the user selects the user's initial storage destination information from four options. When any of the three options including “system default” is selected from the four options, the one piece of desired system path information (system default) is selected from the selection box for the system path information described above.

FIG. 12 illustrates a state where “system default+custom destination” has been selected.

In the entry box for the custom destination on the right side of “system default+custom destination”, the path information up to the storage destination folder where the image data is to be stored is entered, excluding the system default part.
The hierarchical structure of the storage folders illustrated in FIG. 5 may be presented in the form of a diagram so that the folder in the lowest level to be set as the custom destination may be selected.

Similarly, when “custom destination”, which is the fourth option, is selected, the path information up to the storage destination folder where the image data is to be stored is entered in the entry box for the custom destination on the right side of “custom destination”.

After the entry is finished, the user selects the setting end key (not illustrated) or the display area (not illustrated) for ending the setting.

At Step S7, it is checked whether the user identification information (the user name, the user ID, and the password) has been entered.

At Step S32, as in Step S8, it is checked whether the user's initial storage destination information has been selected, and when needed, it is checked whether one system default has been selected from the plurality of “system defaults” and the custom destination has been entered.

At Step S9, when the user identification information and the user's initial storage destination information have been entered and all the entry items of the user registration information have been entered, the process proceeds to Step S10. When all the entry items of the user registration information have not been entered, the process returns to Step S7 to wait for the user registration information to be entered.

At Step S10, the entered user registration information 52 is stored in the storage 50.

Then, the process proceeds to Step S21 in FIG. 18.

At Step S21 of FIG. 18, the user's initial storage destination information is read from the storage 50, and the process proceeds to Step S41.

At Step S41, it is checked whether the selected user's initial storage destination information includes “system default”. When “system default” is included, the process proceeds to Step S42. When “system default” is not included, the process proceeds to Step S25.
At Step S42, the system default selected from the plurality of pieces of system path information (system defaults) is set as the system default path.

Subsequently, in the same manner as in FIG. 16, at Steps S22 to S25, it is checked whether any of the four options has been selected as the user's initial storage destination information.

Furthermore, in the same manner as in FIG. 16, at Steps S26 to S29, the storage destination folder path corresponding to the selected user's initial storage destination information is set.

When only “system default” has been selected at Step S22, the process proceeds to Step S26. When only “system default” has not been selected, the process proceeds to Step S23.

When “system default+user ID” has been selected at Step S23, the process proceeds to Step S27. When “system default+user ID” has not been selected, the process proceeds to Step S24.
When “system default+custom destination” has been selected at Step S24, the process proceeds to Step S28. When “system default+custom destination” has not been selected, the process proceeds to Step S25.
When only “custom destination” has been selected at Step S25, the process proceeds to Step S29. When only “custom destination” has not been selected, the process is terminated.

At Step S26, the set system default path is set as the storage destination folder path, and the process is terminated.

At Step S27, the path including the set system default path and the user ID is set as the storage destination folder path, and the process is terminated.
At Step S28, the path including the set system default path and the custom destination is set as the storage destination folder path, and the process is terminated.
At Step S29, the custom destination stored in the storage 50 is set as the storage destination folder path, and the process is terminated.
In the same manner as in the first embodiment, the display 13 may present the set storage destination folder path so that the user may confirm the set storage destination folder path.

According to the second embodiment, too, the storage destination folder indicated by the set storage destination folder path is the initial storage folder for storing the image data by the user who has made the initial settings.

Afterward, when the user stores the input image data, the input image data is stored in the above-described storage destination folder initially set by the user unless the storage destination folder is explicitly changed.

### Third Embodiment: Case of Changing Storage Destination Folder

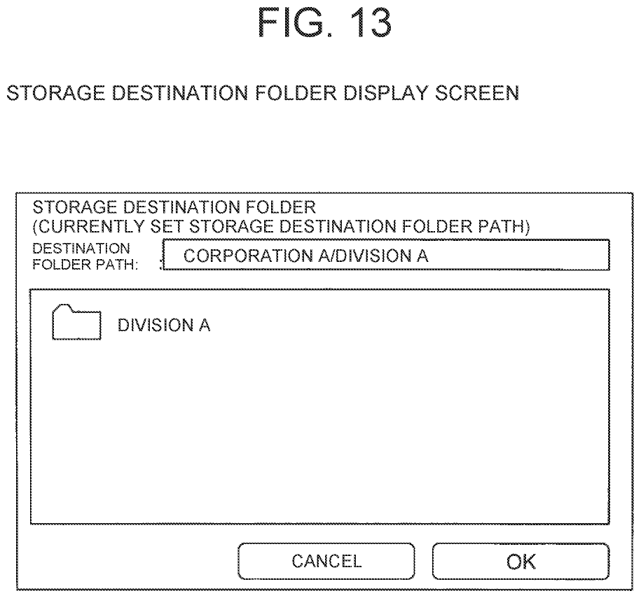

Here, a description is given of the case of changing the storage destination folder initially set by the user.
After the user initially sets the storage destination folder by using the display screen in FIG. 7 described above, the user sometimes desires to change the initially set storage destination folder due to changes in the usage of the image forming apparatus, the frequency of use of the storage folder, etc.
When the user desires to change the initially set storage destination folder, for example, the display 13 may present a display screen for the storage destination folder illustrated in FIG. 13 so as to change the storage destination folder.

FIG. 13 is an explanatory diagram of the display screen for the storage destination folder presented on the display 13 according to an embodiment.

The display screen for the storage destination folder is presented when, for example, the user selects the display area indicating “retrieve the storage destination folder” on a function setting screen (not illustrated) of the image forming apparatus.
The display screen for the storage destination folder presents the current storage destination folder path that is initially set by the user.

FIG. 13 illustrates a state where “corporation A/division A” is presented as the current storage destination folder path in the entry box.

The icon indicates that the current storage destination folder, which is initially set, is “division A”.

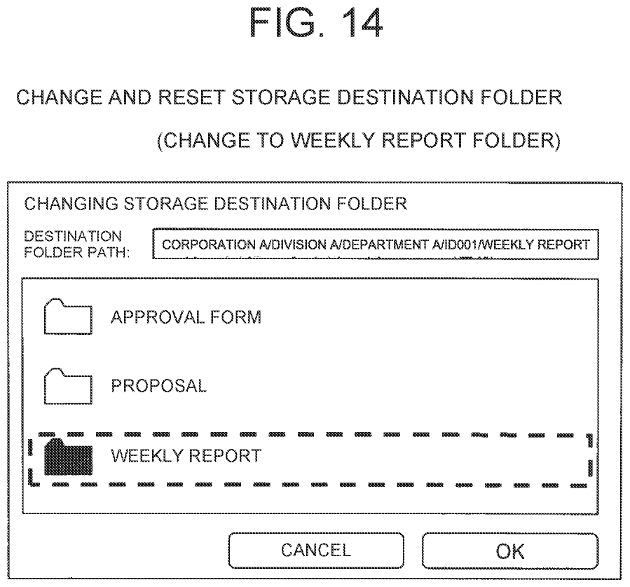

In this display state, for example, the entry box for the storage destination folder path in FIG. 13 is selected so that the display screen illustrated in FIG. 14 is presented to change the storage destination folder path.

FIG. 14 is an explanatory diagram of the display screen for changing the storage destination folder according to an embodiment.
FIG. 14 illustrates a case where the storage destination folder is changed from “division A” to “weekly report”.

For example, the user enters “corporation A/division A/department A/ID001/weekly report” in the entry box for the storage destination folder path in FIG. 14. At this point, in FIG. 14, the icon indicates that the storage destination folder is to be changed to “weekly report”.

Afterward, a display area “OK” is selected to confirm the change so that the storage destination folder is changed to “weekly report” and is stored.

Alternatively, in order to change the storage destination folder path, the hierarchical structure of the storage folders illustrated in FIG. 5 may be presented in the form of a diagram so that the desired storage destination folder after a change may be selected.

This allows the user to easily change the initially set storage destination folder.

### Embodiment of Image Reading Process

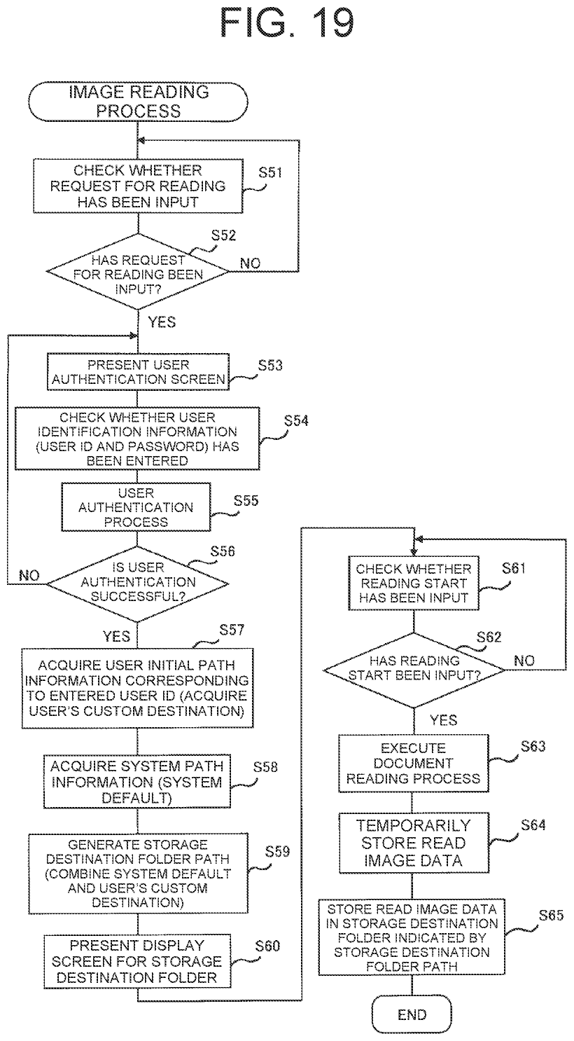

FIG. 19 is a flowchart of the image reading process according to an embodiment.
In the process described here, after the initial setting of the storage destination folder by the user as described above, the desired document is read by the image forming apparatus and the read input image data is stored in the initially set storage destination folder.
In the image reading process described here, in particular, the user has selected “system default+custom destination” as the user's initial storage destination information for the initial setting of the storage destination folder and has set the custom destination.

The user places the document to be read on a predetermined document table, causes the function selection screen of the image forming apparatus to be presented, and selects the display area indicating a reading request.

At Step S51 of FIG. 19, it is checked whether a request for reading a document has been input.
At Step S52, when a request for reading a document has been input, the process proceeds to Step S53. When a request for reading a document has not been input, the process returns to Step S51.

At Step S53, the display 13 presents a user authentication screen.

For example, the user authentication screen illustrated in FIG. 8 is presented.
The user enters the user identification information (the user ID and the password) to the user authentication screen.
At Step S54, it is checked whether the user identification information (the user ID and the password) has been entered. When the user identification information has been entered, a user authentication process is executed at Step S55.

During the user authentication process, the entered user identification information (the user ID and the password) is checked against the user identification information (the user ID and the password) stored in the user registration information to see if they match.

At Step S56, when the two pieces of user identification information match and the user authentication is successful, the process proceeds to Step S57. When the two pieces of user identification information do no match and the user authentication is not successful, the process returns to Step S53 to request the re-entry of the user identification information (the user ID and the password).

At Step S57, the user initial path information corresponding to the entered user ID is acquired from the user registration information 52.

For example, the user initial path information (custom destination) corresponding to the entered user ID is acquired by using the user registration information 52 stored as illustrated in FIG. 2.
At Step S58, the system path information (system default) 53 stored in the storage 50 is acquired.

At Step S59, the storage folder path generator 23 generates a storage destination folder path.

Here, as described above, the acquired system default and the acquired custom destination are combined to generate the storage destination folder path.
At Step S60, the display 13 presents the generated storage destination folder path.
For example, the display screen illustrated in FIG. 9 is presented to prompt the user to confirm whether this storage destination folder is the proper folder where the image data is to be stored.

When the presented storage destination folder is proper, the user selects the display area “scan” indicating the start of reading.

If the user desires to store the image data in a folder different from the presented storage destination folder, for example, the user may select the display area of the entry box for the storage destination folder path, cause the screen illustrated in FIG. 14 described above to be presented, and perform the process to change the storage destination folder path.

At Step S61, it is checked whether the input indicating the start of reading has been made.

At Step S62, when the input indicating the start of reading has been made, the process proceeds to Step S63. When the input indicating the start of reading has not been made, the process returns to Step S61.
At Step S63, a document reading process is executed.
Accordingly, the document is read, and the read image data is generated.

At Step S64, the generated read image data is temporarily stored in a predetermined storage area in the HDD.

At Step S65, the read image data is moved and stored in the storage destination folder indicated by the generated storage destination folder path, and the process is terminated.
As described above, the image data on the read document is stored in the storage destination folder that is initially set by the user.

### Other Embodiments

### Other Embodiment (1): Creating New Storage Destination Folder

According to the above-described embodiment, the folders having the hierarchical structure illustrated in FIG. 5 is previously set, and the storage destination folder is selected from the folders.
However, when the user sets the custom destination, for example, the user sometimes desires to set a new folder as the custom destination instead of an existing folder.
Therefore, for example, on the entry screen for the user registration information of FIG. 7, a selection area “create new folder” is presented near the entry field for the custom destination.

When “create new folder” is selected, a setting screen for a new folder may be presented so as to enter the path information up to the new folder serving as the custom destination.

When the custom destination including the new folder is entered, the entered new folder is added to the hierarchical structure of the folders.

The path information on the entered custom destination is checked when the custom destination is entered in the entry field for the custom destination in FIG. 7 and, when the path information includes a new folder name that is not set in the current hierarchical structure of the folders, the folder with the new folder name may be added to the hierarchical structure of the folders.

### Other Embodiment (2): Transmission to Storage Destination Folder in Other Information Processing Apparatus

Instead of storing the input data such as the read image data in the storage destination folder set in the storage of the image forming apparatus as already described above, the input data may be transmitted from the image forming apparatus to the other information processing apparatus such as a server and stored in a storage destination folder previously set in the other information processing apparatus.
In this case, the storage destination folder of the image forming apparatus described above in the embodiment may be replaced with the storage destination folder of the other information processing apparatus.

The image forming apparatus needs to know the hierarchical structure of folders set in the storage of the other information processing apparatus; therefore, when the image forming apparatus is connected to the other information processing apparatus, the hierarchical structure of the folders in the storage of the other information processing apparatus needs to be acquired, and the initial setting of the storage destination folder path needs to be made previously by the user.

To designate a storage destination folder of the other information processing apparatus as a storage destination for the input read image data, for example, the storage destination folder path initially set by the user is transmitted together with the read image data when the read image data is transmitted to the other information processing apparatus.
The other information processing apparatus may store the read image data in the storage destination folder indicated by the received storage destination folder path.

Alternatively, when the user initially sets the storage destination folder path of the other information processing apparatus, the storage destination folder path and the user name may be transmitted to the other information processing apparatus, and the storage destination folder path received by the other information processing apparatus may be stored as the storage destination folder path initially set by the user in association with the received user name.

In this case, when the read image data is transmitted to the other information processing apparatus, the user name may be transmitted together with the read image data, and the read image data may be stored by the other information processing apparatus in the storage destination folder indicated by the storage destination folder path stored in association with the received user name.

What is claimed is:

1. An information processing apparatus comprising:
a user path setter that initially sets, for each user, initial path information up to a storage destination folder for storing input data;
a storage folder path generator that generates a storage destination folder path indicating a hierarchical structure up to the storage destination folder and including the initial path information as a part of the hierarchical structure; and
a data storage executor that, when data related to a user is input by the user, stores the data input by the user in the storage destination folder by using the generated storage destination folder path, wherein
the initial path information includes a custom destination that is user-specific path information initially set by each user.

2. The information processing apparatus according to claim 1, further comprising a user identification information setter that initially sets user identification information including user identification, wherein
the custom destination includes path information indicating a hierarchical structure from an identification folder, with which the initially set user identification is identifiable, up to the storage destination folder.

3. The information processing apparatus according to claim 1, further comprising a system path setter that initially sets system path information that is common path information to users of the information processing apparatus as path information up to the storage destination folder for storing data, wherein
the storage destination folder path is generated as path information combining the system path information and the custom destination.

4. The information processing apparatus according to claim 1, further comprising an operator and a display, wherein
the display presents a diagrammatic screen using a hierarchical structure to indicate a relationship of a plurality of folders up to the storage destination folder, and
the user uses the operator to select a folder to be set as a storage location for storing data from the plurality of folders presented on the diagrammatic screen and thus initially sets the custom destination.

5. The information processing apparatus according to claim 1, further comprising a storage in which a plurality of folders is previously set and is associated with each other by a predetermined hierarchical structure, wherein
the storage destination folder for storing data input by a user is any of the plurality of folders.

6. The information processing apparatus according to claim 1, further comprising a communicator that transmits data to another information processing apparatus via a network, wherein
the another information processing apparatus includes a storage in which a plurality of folders is previously set and is associated with each other by a predetermined hierarchical structure,
the storage destination folder is a folder previously set in the storage of the another information processing apparatus,
the communicator designates the storage destination folder as a storage destination for the input data and transmits the input data to the another information processing apparatus, and
the data received by the another information processing apparatus is stored in the storage destination folder in the storage of the another information processing apparatus.

7. A storage destination management method for an information processing apparatus, the information processing apparatus including a storage in which a plurality of folders is previously set and is associated with each other by a predetermined hierarchical structure, the storage destination management method comprising:
when a user selects a desired folder from the plurality of folders in the storage, initially setting, for each user, initial path information up to a storage destination folder that is a storage location for storing input data so as to set the selected folder as the storage destination folder;
generating a storage destination folder path indicating a hierarchical structure up to the storage destination folder and including the initial path information as a part of the hierarchical structure; and
when data related to a user is input by the user, storing the data input by the user in the storage destination folder by using the generated storage destination folder path.
